(19) United States
(12) Patent Application Publication
(10) Pub. No.: US 2006/0067639 A1
(43) Pub. Date: Mar. 30, 2006

(54) Light pipe module

(75) Inventor: Ying-Fang Lin, Taoyuan City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/230,579

(22) Filed: Sep. 21, 2005

(30) Foreign Application Priority Data
Sep. 24, 2004 (TW) 93128978

(51) Int. Cl. G02B 6/10

(52) U.S. Cl. 385/146

(57) ABSTRACT

A light pipe module. A light pipe including a first wall having a first position at which a force is exerted and a bonding position adjacent to the first position accommodated in a protector comprising a protection element disposed on the bonding position, thereby preventing damage to the light pipe.

### BACKGROUND

The invention relates to a light pipe module and in particular to a light pipe module with a protector.

FIG. 1 depicts a schematic diagram of a digital light processing projector (DLP projector) system. Light from a light source 10 travels through a color wheel 20 of high rotational speed and enters a light pipe 30. The light entering the light pipe 30 is refracted and transmitted to an image device 40 collecting light to create an image projected on a screen 50.

As the light from the light source 10 precisely enters the image device 40 only via the refraction of the light pipe 30, the positioning and adjustment of the light pipe 30 becomes very important. The light pipe 30 as shown in FIG. 2 comprises four assembled glass plates, 32, 34, 36 and 38. If one of the four glass plates is pushed strongly, the entire structure of the light pipe 30 may crush. A protector is, therefore, provided for the light pipe 30. A conventional protector is shown in FIG. 3. The light pipe 30 is accommodated in a metal rectangular tube 100 and bonded thereon with adhesives. The adhesive is added to bond the end surfaces of the rectangular tube 100 and the light pipe 30 respectively, and the bonding position is marked by numeral 120. The rectangular tube 100 is positioned in horizontal and vertical directions by bolts 140 and 160 respectively. As a datum plane is needed to orient the light pipe 30 in the horizontal direction, two openings 1021, 1022 are defined on one wall 102 of the rectangular tube 30 to reveal the glass plate 34 contacting two positioning posts 150 defining a datum plane. Two openings (not shown) are defined on a wall 104 (adjacent to the wall 102) of the rectangular tube 100 to reveal the glass plate 36 contacting two positioning posts 150 which define a datum plane in the vertical direction.

Nevertheless, in such a structure shown in FIG. 3, the positioning posts 150 push the glass plate 34 with a force P1, and the adhesive at bonding position 120 pulls the glass plate 34 with a force P2. As the push force P1 and the pull force P2 are not collinear and separated by a considerable distance, a torque is created bending the glass plate 34 and probably further to crush the light pipe 30.

### SUMMARY

A light pipe module according to an embodiment of the invention comprises a light pipe comprising a first wall having a first position at which a force is exerted and a bonding position adjacent to the first position, and a protector for the light pipe comprising a protection element disposed on the first wall and bonded to the bonding position.

The light pipe is accommodated in the protector which is rectangular, and the protection element is disposed on one side of the rectangular protector.

### BRIEF DESCRIPTION OF THE DRAWINGS

The invention can be more fully understood by reading the subsequent detailed description and examples with references made to the accompanying drawings, wherein:

FIG. 1 is schematic diagram of a digital light processing projector (DLP projector) system;

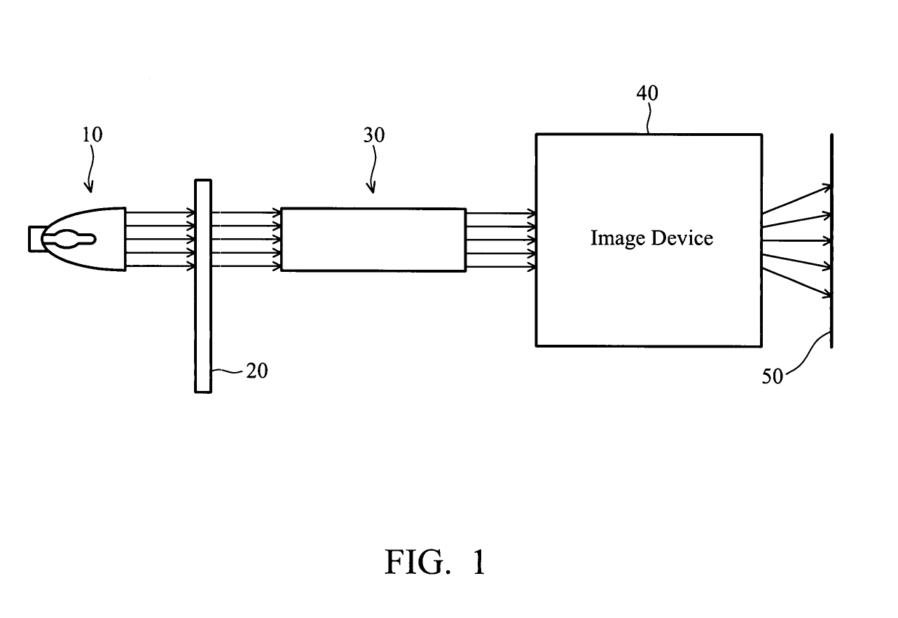

FIG. 2 is a perspective view of a light pipe;

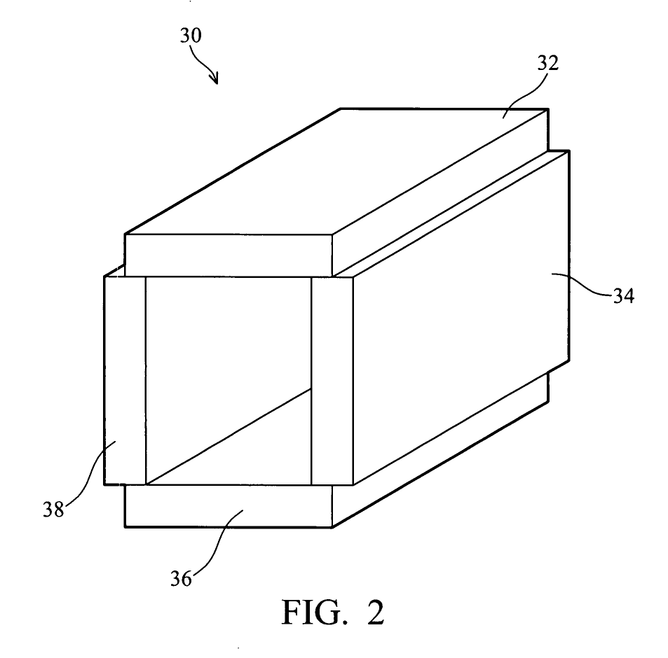

FIG. 3a is a perspective view of a conventional light pipe module;

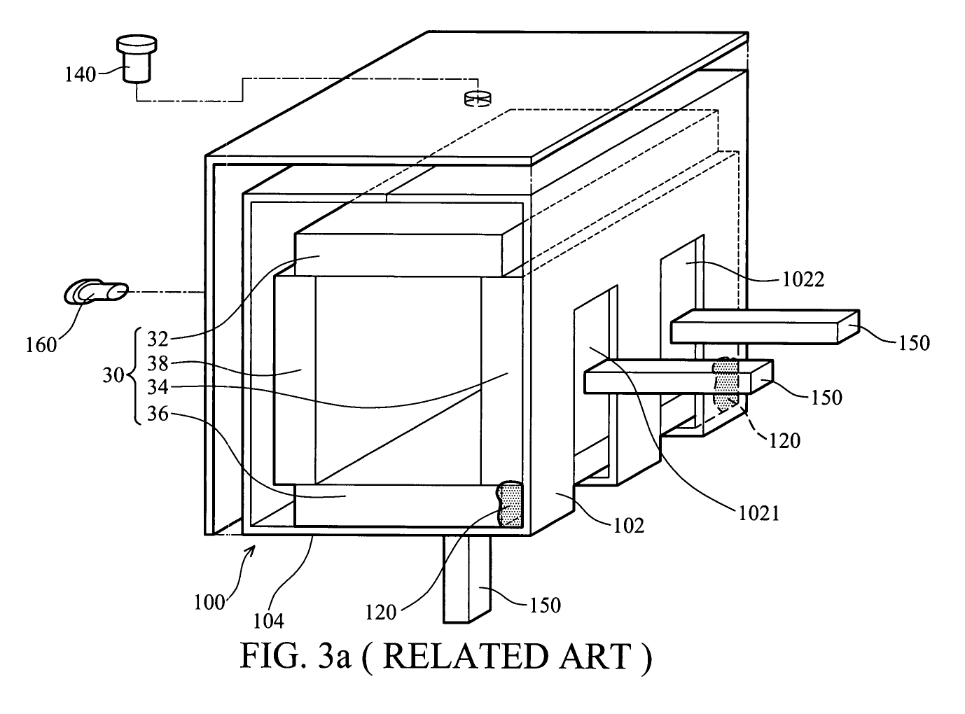

FIG. 3b is a schematic view depicting forces acting on the light pipe of FIG. 3a;

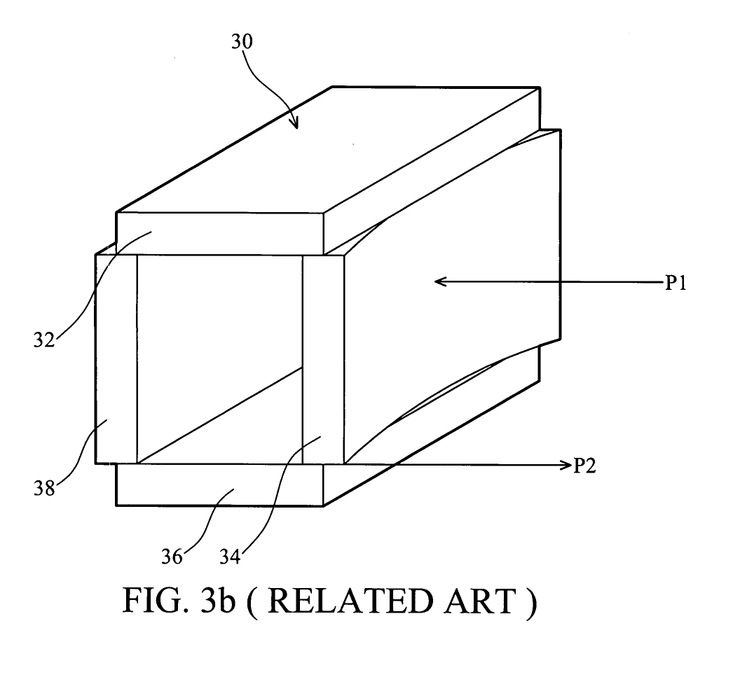

FIG. 4a is a perspective view of a light pipe module according to an embodiment of the invention; and

FIG. 4b is a schematic view depicting forces acting on the light pipe of FIG. 4a.

### DETAILED DESCRIPTION

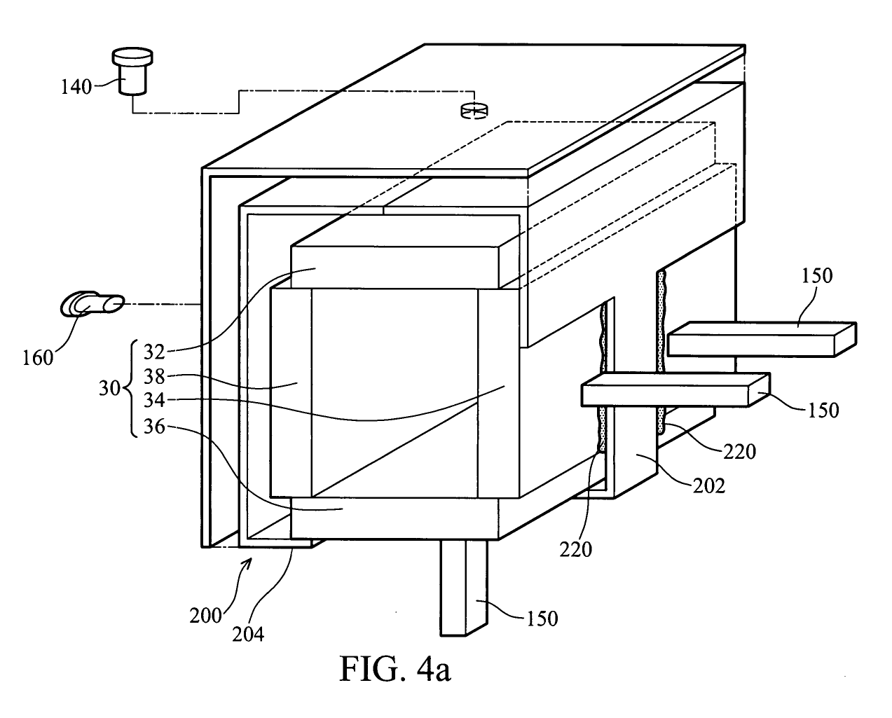

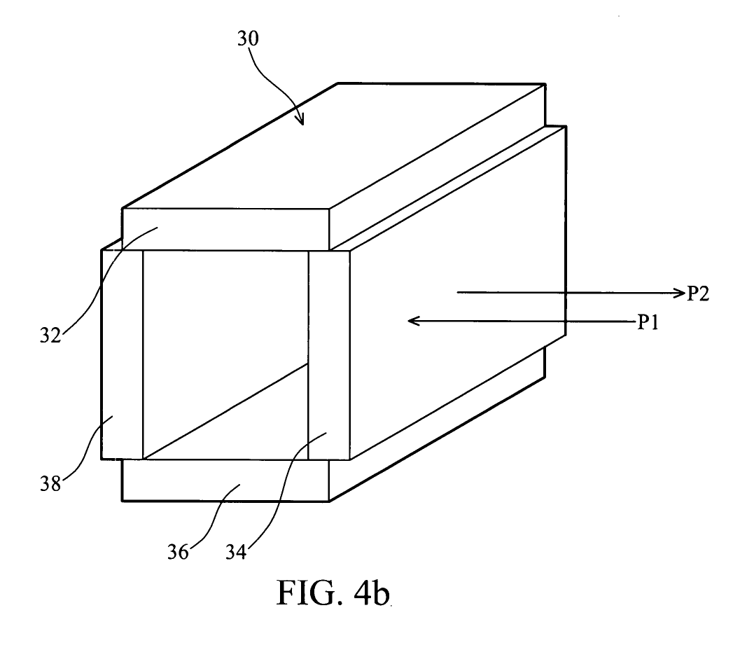

Referring to FIG. 4, a light pipe 30 is accommodated in a metal rectangular tube (protector) 200. A T-shaped protection element (first protection element) 202 disposed on one side of the rectangular tube 100 covers a glass plate (first wall) 34 of the light pipe 30 and is bonded thereto. A bonding position 220 on the glass plate 34 at which adhesives are added corresponds to the root of the T-shaped protection element 202.

Another T-shaped protection element (second protection element) 204 disposed on the bottom of the rectangular tube 200 covers a glass plate (second wall) 36 and is bonded thereto. A bonding position (not shown) on the glass plate 36 also corresponds to the root of the T-shaped protection element 204. The root of the T-shaped protection element 202 is adjacent to the root of the T-shaped protection element 204.

In the structure of the embodiment, as shown in FIG. 4, because the position (first position) at which positioning post 150 defining a datum plane contacts the light pipe 30 is adjacent to the bonding position 220, the position of the push force exerted by the post 150 is near the position of the pull force exerted by the adhesive on the bonding position 220, and the torque on the glass plate 34 created by the push and pull forces is, therefore, too small to crush the light pipe 30.

Although a T-shaped protection element is used in the previous described embodiment, the shape of the protection element, however, is not limited thereto. It is included in the scope of the invention that as long as the position at which the positioning post exerts force is near the bonding position.

While the invention has been described by way of example and in terms of embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light pipe module contacted by positioning posts, comprising:
a light pipe comprising a first wall having a first position at which a force is exerted and a bonding position adjacent to the first position; and
a protector for the light pipe comprising a protection element disposed on the first wall and bonded to the bonding position.

2. The light pipe module as claimed in claim 1, wherein the light pipe is accommodated in the protector which is rectangular, and the protection element is disposed on one side of the rectangular protector.

3. The light pipe module as claimed in claim 2, wherein the protection element is T-shaped and the bonding position corresponds to the root of the T shape.

4. A light pipe module contacted by positioning posts, comprising:
a light pipe comprising a first wall having a first position at which a force is exerted and a first bonding position adjacent to the first position, and a second wall adjacent to the first wall and having a second position at which another force is exerted and a second bonding position adjacent to the second position; and
a protector for the light pipe comprising:
a first protection element disposed on the first wall and bonded to the first bonding position; and
a second protection element disposed on the second wall and bonded to the second bonding position.

5. The light pipe module as claimed in claim 4, wherein the light pipe is accommodated in the protector which is rectangular, and the first protection element is disposed on one side of the protector and the second protection element is disposed on another side thereof.

6. The light pipe module as claimed in claim 5, wherein the first and second protection elements are T-shaped and the first and second bonding positions correspond to the roots of the first and second T-shaped protection elements respectively.

7. The light pipe module as claimed in claim 6, wherein the root of the first T-shaped protection element is adjacent to the root of the second T-shaped protection element.
